(19) United States
(12) Patent Application Publication
(10) Pub. No.: US 2007/0252763 A1
(43) Pub. Date: Nov. 1, 2007

(54) Passive Transmitter Receiver Device Fed by an Electromagnetic Wave

(76) Inventor: Jean-Marc Martin, Saint Leu La Foret (FR)

Correspondence Address: CANTOR COLBURN, LLP, 55 GRIFFIN ROAD SOUTH, BLOOMFIELD, CT, 06002, US

(21) Appl. No.: 10/586,762

(22) PCT Filed: Jan. 19, 2005
(86) PCT No.: PCT/FR05/00117

§ 371 Date: Apr. 25, 2007

(30) Foreign Application Priority Data
Jan. 19, 2004 (FR) 0400442

(51) Int. Cl. H01Q 1/24

(52) U.S. Cl. 343/702

(57) ABSTRACT

The invention relates to a passive transmitter-receiver device (6,28,33) fed by an electromagnetic wave, provided with an antenna comprising a loop (7, 30, 34) which is associated with an electronic transponder chip (9), said loop being able to feed the electronic chip by an induced current which is generated when it is cross-flown by an electromagnetic wave (H1, H2, H3, Ha, Hr) carrying information, and to transmit a second electromagnetic wave carrying a response from the electronic chip. The antenna is configured in such a way that the loop includes at least two non-coplanar or non-parallel parts in a position of use.

### BACKGROUND OF THE INVENTION

The present invention relates to a passive receiver-transmitter device powered by an electromagnetic wave carrying information.

The operation of such devices relies on a transmission by induction between, on the one hand, a card or a label having an antenna in the form of a loop, the ends of which are linked to an electronic chip on the card or the label, and, on the other hand, a terminal capable of sending and receiving an electromagnetic wave carrying information. The antenna of the card or label captures the electromagnetic wave sent by the terminal and transmits the information to the chip which processes it before, if necessary, sending a response that is forwarded by the antenna and will be captured by the terminal. Thus, the latter can read and/or modify the information stored on the card.

Such devices are used to implement so-called “contactless” data transfer methods, used, for example, for remote identification systems, for anti-theft and transport ticket validation systems, and for identifying and tracking packages in a warehouse. These devices are normally known as radiofrequency identification devices (RFID).

One of the great advantages of these devices, besides the fact that they require no direct contact between the chip and the reader, is that they are passive, in other words, they require no independent electrical power source. In practice, when an electromagnetic wave, having a frequency adjacent to the resonance frequency of the antenna, passes through the antenna perpendicularly to the plane of the loop, it generates an induced current which can then be used to feed an electronic circuit such as a chip.

However, the way in which these cards are fed also constitutes their main drawback. In practice, for an induced current to be generated, the magnetic field of the wave must be directed roughly perpendicularly to the plane of the loop. While the issue of the orientation of the magnetic field poses few problems for applications requiring a relatively determined position, such as identification validators or badges, the same does not apply when the object to be identified is in motion or has an unpredictable positioning. Such is in particular the case when there is a desire to apply this technology to the tracking of athletes in competitions or the identification of packages in a warehouse.

### DESCRIPTION OF THE PRIOR ART

One first solution is to place a number of terminals so as to cover the maximum possible number of orientations of the antenna. This solution is expensive and requires a complex computerized management of the different terminals in order to avoid duplicate validations if the object to be detected is in motion.

Another solution is to place a label containing an electronic transponder chip on each side of the object to be detected so as to cover the three possible directions of incidence of the magnetic field sent by the terminal. Thus, the field will in all cases be sensed by at least one label. However, it is also possible for more than one label to react to the magnetic field and it is therefore necessary to also provide a controlling computerized facility with which, on the one hand, to collate the various labels glued to one and the same object and on the other hand, to manage any crossed detection. Moreover, if there is a desire to modify the information concerning the object, stored on the chip, it becomes necessary to modify the chips of all the labels of the object. All the labels of one and the same object do not necessarily capture the electromagnetic wave, so such an updating of the chips is difficult to envisage.

Document FR 2 812 427 discloses another solution, in which an antenna is deployed on a number of separate adhesive supports, each comprising a winding disposed in a particular plane, the windings being disposed remotely to avoid one winding being disturbed in relation to another winding.

This device is satisfactory for a definitive installation on a large, pallet-type object.

However, it does not allow for the use of a small-size support, smaller than a meter and even more so smaller than 50 cm, that can be easily applied to an object or carried by an individual.

Furthermore, this antenna does not allow for detection in a plane perpendicular to the pallet.

### SUMMARY OF THE INVENTION

The object of the present invention is to overcome the drawbacks described above, and, for this, consists of a passive receiver-transmitter device fed by electromagnetic wave, provided with an antenna comprising a loop associated with an electronic transponder chip, this loop being able on the one hand to feed the electronic chip with an induced current generated when it is passed through by a first electromagnetic wave carrying information, and on the other hand, to send a second electromagnetic wave carrying the response from the electronic chip, characterized in that the antenna is designed in such a way that the loop comprises at least two non-coplanar or non-parallel parts in a position of use.

In this way, the antenna has an overall, non-planar receive surface, and is therefore capable of capturing electromagnetic waves in a number of directions. More specifically, the antenna can capture the waves with a magnetic field that has at least one component oriented roughly perpendicularly to a portion of the antenna. It should be understood that the term antenna denotes all or part of the radiofrequency system designed to radiate or capture the waves.

The present invention provides for a simple, small solution, which can easily be applied to an object or an individual.

Advantageously, the loop comprises at least two parts situated in roughly perpendicular planes. This configuration makes the device particularly well suited to the tracking of packages or packets.

According to a first embodiment of the invention, the loop is intended to be disposed in two planes roughly perpendicular to each other.

Advantageously, the loop is intended to be positioned in three planes roughly perpendicular to each other. In this way, the antenna covers the three directions of the space and can therefore capture the electromagnetic waves whatever their orientation.

Preferably, the antenna is incorporated in a support intended to be glued on several sides of one and the same object. Advantageously, the support is produced in the form of a self-adhesive label.

According to a second embodiment of the invention, the antenna comprises a loop produced in the form of an open cylindrical bracelet, obtained from a flat support formed by a flexible strip.

According to a third embodiment of the invention, the antenna comprises a closed circular loop produced from a spiral-wound wire.

Advantageously, the loop has a diameter of between 4 and 10 cm.

### BRIEF DESCRIPTION OF THE DRAWINGS

Such devices according to the second and third embodiments of the invention can easily be worn around the wrist or ankle of a person and are therefore particularly well suited to tracking athletes. Preferably, the loop has a diameter of between 4 and 10 cm.

The invention will be better understood from the detailed description that is given below in light of the appended drawings in which:

FIG. 1 is a diagrammatic view of a package on which is glued a device according to a first embodiment of the invention.

FIG. 2 is an enlarged diagrammatic view of a device glued to the package represented in FIG. 1.

FIG. 3 is a diagrammatic view of the device of FIG. 2 before it is glued on the package.

FIG. 4 diagrammatically represents the disposition of the loop of the device of FIG. 1.

FIG. 5 is a curve representing the variation of the resonance frequency as a function of the distance from the loop to a corner of the packet around which the device of FIG. 1 is folded.

FIG. 6 represents a variant of the device of FIG. 3.

FIG. 7 is a diagrammatic view of a strip, comprising a device according to the second embodiment of the invention, before it is shaped.

FIG. 8 is a diagrammatic view of the strip represented in FIG. 7, after it is shaped around a cylinder.

FIG. 9 is a curve representing the variation of the resonance frequency as a function of the diameter of the cylinder of FIG. 8.

FIG. 10 is a diagrammatic top view of a device according to the third preferred embodiment of the invention.

FIG. 11 is a diagrammatic perspective view of the device represented in FIG. 10, placed around a cylinder.

FIG. 12 is a curve representing the variation of the resonance frequency as a function of the diameter of the cylinder represented in FIG. 10.

FIG. 13 is a diagrammatic perspective view of a device according to a fourth preferred embodiment of the invention.

FIG. 14 is a diagrammatic perspective view of a device according to a fifth preferred embodiment of the invention.

FIG. 15 is a diagrammatic perspective view of a device according to a sixth preferred embodiment of the invention.

### DESCRIPTION OF THE PREFERRED EMBODIMENTS

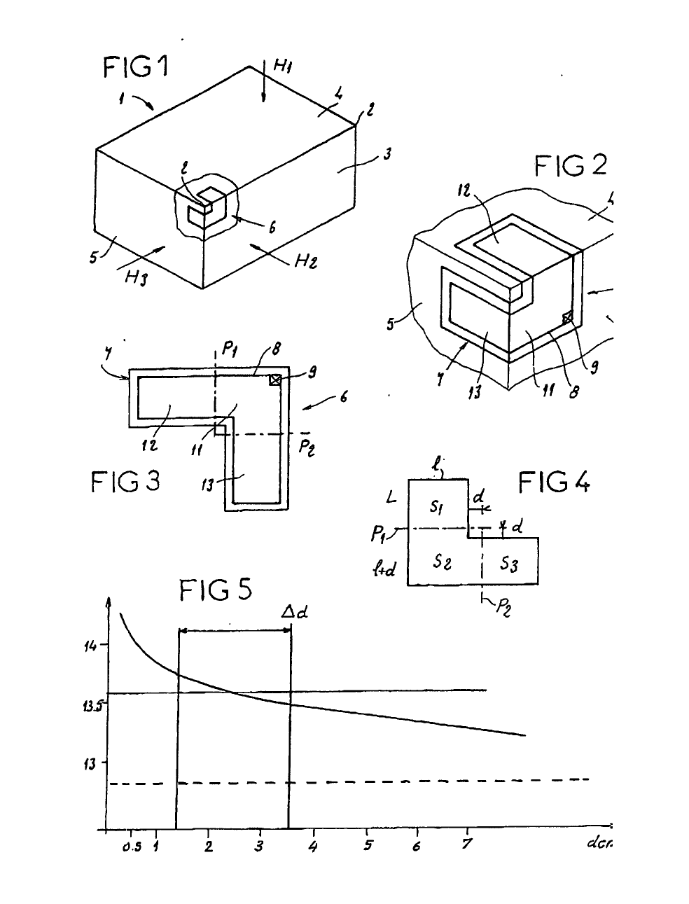

A parallelepipedal package 1, as represented in FIG. 1, has eight corners 2, each corner 2 being delimited by three sides 3, 4, 5 perpendicular to each other. A device 6 according to a first embodiment of the invention is glued to one corner 2 so as to be in contact with the three sides 3, 4, 5, as represented in FIG. 2.

To do this, the device 6 takes the form of a flat label, represented in FIG. 3, comprising an adhesive support 7 in the shape of a bracket made of a foldable flexible material such as paper or polymer film. A conductive wire 8, having two ends, is deposited around the edge of the support 7 so as to form a loop also in the shape of a bracket. The conductive wire 8 can be joined to the support 7 or not. Alternatively, the loop can also be produced in the form of a conductive track obtained by metallic deposition or from a conductive ink.

The ends of the wire 8 are linked to the power supply terminals of an electronic transponder chip 9. Such an electronic chip 9 is known per se and is of the type used for RFIDs, designed to operate at frequencies above 10 MHz, normally 13.56 MHz, and the operating standards of which are mainly set by the ISO standards.

The electronic circuit comprising, on the one hand, the conductive wire 8 forming a loop, and on the other hand, the electronic transponder chip 9, is designed to form a resonator, the loop of which forms the antenna. This type of circuit is also known. The antenna is produced so that the resonance frequency of the system corresponds to the operating frequency of the chip, i.e. 13.56 MHz. If the capacity of the electronic chip 9 is insufficiently high compared to the inductance of the loop, a capacitor (not shown in the drawings), of appropriate rating, will be connected in parallel to the electronic chip 9.

Once the electronic circuit is placed on the support 7, a protective film (not represented) is applied.

Fold lines P1, P2 are then marked on the support 7 in the shape of a bracket. Each of the lines P1, P2 is situated on one branch of the support 7, so as to divide the label into three portions 11, 12, 13. Each of the portions 11, 12, 13 includes a part of the loop formed by the wire 8 representing approximately a third of the overall area of the loop. Thus, the three portions 11, 12, 13 have roughly identical receive surface areas.

It is important to choose the dimensions and the disposition of the loop in such a way as to obtain electromagnetic characteristics suited to the use in the chosen frequency range.

Thus, the following adjustment can, by way of example, be made, by imposing equality of the surface areas of the loop in the different planes.

Starting from an L-shaped structure as represented in FIGS. 1 to 4, designed to be folded along two lines P1 and P2, three surface areas can be defined, respectively intended to be disposed in three different planes, the three surface areas S1, S2, S3 being separated by fold lines and roughly corresponding to a first branch of the L, the join area between the two branches of the L, and the second branch of the L.

The following conventions are used:
d is the distance between a branch of the L and the intersection of the fold lines P1 and P2,
L is the length of a branch of the L and the intersection of the fold lines P1 and P2,
l is the width of the branches of the L.

Consequently:
S1=Ll
S2=(l+d)²−d²=l²+2ld
S3=Ll.

Since the magnetic field passes through one of the three surface areas S1, S2, S3, these three surface areas need to be roughly the same size.

By defining:
L=kl, characteristic relationship of one side of the label,
L+l+d=C, overall length of the side of the square in which the unfolded label fits.

To have S1=S2=S3, we obtain:

$$d = \frac{L - 1}{2} = ( \frac{k - 1}{2} ) 1$$

$$c = 1 \frac{3 k + 1}{2}$$

Normally, k is fixed by the rectangular label format of one side. More often than not, it is equal to 1.3.

For example, if it is decided that C=2.5 cm and k=1.3, then l=50/4.9˜10.2 cm; L=13.26 cm and d=1.53 cm.

The following measurements have also been made.

With the label designed flat, FIG. 5 shows how its resonance frequency changes when the label is distorted for different values of d.

Thus, the values of d that can be used to obtain a resonance frequency close to that required, which in the example is 13.56 MHz, are within a band of values Δd between 1.3 cm and 3.5 cm.

It therefore appears that the values of d that can be used include those determined by using the equal surface areas method.

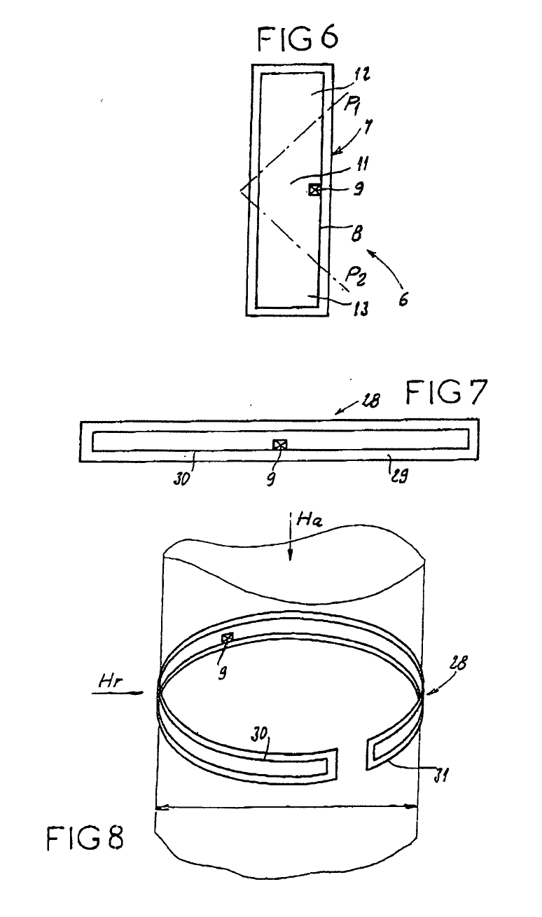

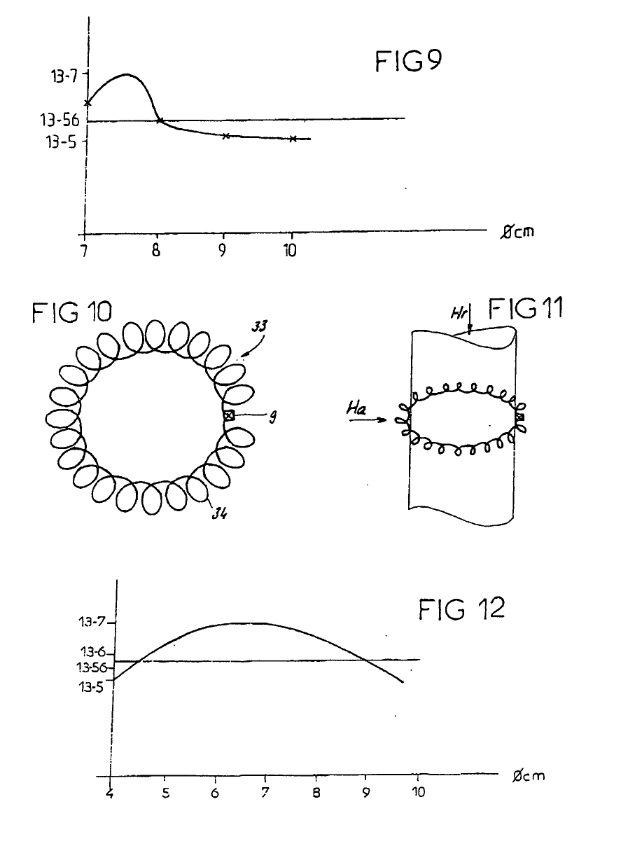

FIG. 6 represents an execution variant of the label of FIG. 3, in which the same elements are denoted by the same references as before. In this case, the label, when flat, has a rectangular shape.

In its condition of use, the part 11 is glued to the side 3, near to the corner 2, so that the lines P1, P2 are each situated on one edge of the corner. In this case, the line P1 is located on the edge between the side 3 and the side 4, and the line P2 is located on the edge between the side 3 and the side 5. The parts 12, 13 are then folded along their respective lines P1, P2 to be glued onto the sides 4, 5 of the package 1.

Once in place, the label therefore has three receiving surface areas perpendicular to each other, corresponding to the portions 11, 12, 13. Since each surface area is able to receive an electromagnetic wave oriented roughly perpendicularly to itself, the device therefore defines a three-dimensional orthogonal frame of reference covering all possible orientations. In practice, any electromagnetic wave will have components H1, H2 and H3 within this frame of reference and will therefore be captured by the loop. It is interesting to note that an excitation by a one-way magnetic field H1 or H2 or H3 is sufficient to make the entire loop resonate and to feed the chip 9 with sufficient energy to function.

A device 28, according to a second embodiment of the invention and as represented in FIGS. 7 and 8, comprises a flat support 29 in the form of a flexible strip. A wire 30 is placed around the edge of the support 29 to form a rectangular loop and is connected to an electronic chip 9. The support 29 is covered by a protective film, then the device is glued onto an open bracelet 31 having dimensions close to those of the support 29. In conditions of use, the open bracelet 31 is placed around a roughly cylindrical body, such as a wrist or an ankle so as to form a bracelet. The loop formed by the wire 30 then has an open bracelet structure and therefore presents receiving surface areas with which to capture the radially oriented waves Hr and the waves Ha oriented along the axis of the cylinder.

The fact that the bracelet 31 is an open bracelet means that the device 28 can easily be adapted to different diameters. The surprising particular feature of a loop with an open bracelet structure is that the resonance frequency and the overvoltage coefficient of the device vary little when its diameter changes slightly. The curve showing the variation of the frequency as a function of the diameter is represented in FIG. 10 for a bracelet 31 tuned to 13.56 MHz when its diameter is 8 cm. When the diameter of the bracelet varies between 7 and 10 cm, the resonance frequency remains around the nominal frequency of 13.56 MHz.

A device 33, produced according to the third preferred embodiment of the invention, is represented in FIGS. 10 and 11. This device 33 comprises a spiral-wound wire 34 closed on itself so as to form a circular loop having two ends linked to an electronic chip 9. In conditions of use, this device 33 is placed around a body having roughly the shape of a cylinder, such as an ankle or a wrist, and presents receiving surface areas with which to essentially capture waves Ha oriented along the axis of the cylinder.

Moreover, the elasticity of the spiral means that the device 33 can easily be adapted to different diameters without any specific opening device. As for the device 28, according to the third embodiment, it has been observed that the resonance frequency varies little with the diameter. The curve of the resonance frequency as a function of the diameter of the loop is represented in FIG. 12.

FIG. 13 represents a device 35 according to a fourth embodiment, intended to be glued onto the corner of a package, as in the first embodiment, comprising a wire describing on each side of the packet two perpendicular sections, so as to form a left hexagon around one corner of the packet, the chip 37 being situated, for example, on a vertex of the hexagon.

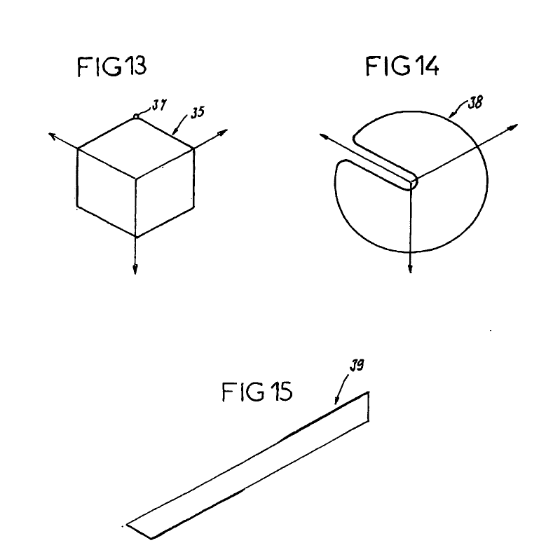

FIG. 14 represents a device 38 according to a fifth embodiment intended to be glued onto the corner of a package, as in the first embodiment, which is similar to the first embodiment except that its shape is not in the form of an L with straight line segments, but with a rounded outer shape.

FIG. 15 represents a sixth embodiment of a device 39, the loop being formed by a rectangle which is twisted about a twist axis parallel to its length, in order to form a left surface area with which to receive waves in a number of directions.

Although the invention has been described in conjunction with particular exemplary embodiments, it is clearly obvious that it is by no means limited and that it includes all the technical equivalents of the means described, and their combinations if such enter into the context of the invention.

1. A passive receiver-transmitter device fed by electromagnetic wave, provided with an antenna comprising a loop associated with an electronic transponder chip, this loop being able on the one hand to feed the electronic chip with an induced current generated when it is passed through by a first electromagnetic wave carrying information, and on the other hand, to send a second electromagnetic wave carrying the response from the electronic chip, characterized in that the antenna is designed in such a way that the loop comprises at least two non-coplanar or non-parallel parts in a position of use.

2. The device as claimed in claim 1, wherein the loop comprises at least two parts situated in roughly perpendicular planes.

3. The device as claimed in claim 2, wherein the loop is intended to be disposed in two planes roughly perpendicular to each other.

4. The device as claimed in claim 2, wherein the loop is intended to be positioned in three planes roughly perpendicular to each other.

5. The device as claimed in claim 1, wherein the antenna is incorporated in a support intended to be glued on several sides of an object.

6. The device as claimed in claim 5, wherein the support is produced in the form of a self-adhesive label.

7. The device as claimed in claim 1, wherein the antenna comprises a loop produced in the form of an open cylindrical bracelet, obtained from a flat support formed by a flexible strip.

8. The device as claimed in claim 1, wherein the antenna comprises a closed circular loop produced from a spiral-wound wire.

9. The device as claimed in claim 7, wherein the loop has a diameter of between 4 and 10 cm.

10. The device as claimed in claim 8, wherein the loop has a diameter of between 4 and 10 cm.

11. The device as claimed in claim 2, wherein the antenna is incorporated in a support intended to be glued on several sides of an object.

12. The device as claimed in claim 3, wherein the antenna is incorporated in a support intended to be glued on several sides of an object.

13. The device as claimed in claim 4, wherein the antenna is incorporated in a support intended to be glued on several sides of an object.
